(19) United States
(12) Patent Application Publication
(10) Pub. No.: US 2025/0377749 A1
(43) Pub. Date: Dec. 11, 2025

(54) TOUCH CONTROL MODULE

(71) Applicant: ASUSTEK COMPUTER INC., TAIPEI (TW)

(72) Inventors: Chao-Chieh CHENG, TAIPEI (TW); Yi-Ou WANG, TAIPEI (TW); Chun-Mao TSENG, TAIPEI (TW); Wei-Chuan CHEN, TAIPEI (TW); Li-Xuan ZHU, TAIPEI (TW); Mu-Chern FONG, TAIPEI (TW); Ying-Kai CHUNG, TAIPEI (TW); Min DAI, TAIPEI (TW); Yi-Wei LEE, TAIPEI (TW); Yu-Jen CHEN, TAIPEI (TW)

(21) Appl. No.: 18/941,671

(22) Filed: Nov. 8, 2024

(30) Foreign Application Priority Data
Jun. 5, 2024 (TW) 113120828

(51) Int. Cl. G06F 3/041; G06F 3/0354

(52) U.S. Cl. CPC G06F 3/04166; G06F 3/03547; G09G 3/26

(57) ABSTRACT

A touch control module is provided. The touch control module includes a touch pad and at least one light-emitting element. A front side of the touch pad includes a touch surface, the touch surface includes a translucent region, and the touch surface includes a dial pattern at a position corresponding to the translucent region. The dial pattern includes an inner circle pattern region and an outer ring pattern region. The at least one light-emitting element is arranged at a back side of the touch pad, and corresponds to the translucent region.

### CROSS-REFERENCE TO RELATED APPLICATION

This application claims the priority benefit of Taiwan application serial No. 113120828, filed on Jun. 5, 2024. The entirety of the above-mentioned patent application is hereby incorporated by reference herein and made a part of the specification.

### BACKGROUND OF THE INVENTION

### Field of the Invention

The disclosure relates to a touch control module, and in particular, to a touch control module having a dial pattern on a surface thereof.

### Description of the Related Art

With the development of science and technologies, users have an increasing high requirement on a human-machine operation interface of an electronic device. Existing touch pads with functions of simply operating a cursor and supporting multi-finger gestures are no longer sufficient for use.

In addition, compared with a touch pad, a dial provides a user with different operation manners and functions. However, when the dial is provided in the electronic product (such as a notebook computer), there is often a problem of insufficient internal space of the electronic product.

### BRIEF SUMMARY OF THE INVENTION

The disclosure provides a touch control module. The touch control module includes a touch pad and at least one light-emitting element. A front side of the touch pad includes a touch surface, the touch surface includes a translucent region, and the touch surface includes a dial pattern at a position corresponding to the translucent region. The dial pattern includes an inner circle pattern region and an outer ring pattern region. The at least one light-emitting element is arranged at a back side of the touch pad, and corresponds to the translucent region.

The touch control module provided in the disclosure forms the dial pattern on the touch pad, and includes the translucent region that generates a light-emitting pattern to prompt a user. This helps the user to use the touch pad to operate a dial, so as to expand functions of the touch pad. In addition, in the disclosure, the dial pattern is formed on the touch pad to provide a dial function, which avoids a problem of insufficient internal space of an electronic device when a physical dial is provided on the electronic device.

### BRIEF DESCRIPTION OF THE DRAWINGS

FIG. 1 is a schematic outside view of a touch control module according to a first embodiment of the disclosure;

FIG. 2 is a schematic cross-sectional view corresponding to a section line A-A in FIG. 1;

FIG. 3 is a schematic cross-sectional view of a touch control module according to a second embodiment of the disclosure;

FIG. 4A and FIG. 4B show two embodiments of translucent regions within an inner circle pattern region of a dial pattern;

FIG. 5A to FIG. 5C show three embodiments of translucent regions located at a junction of an inner circle pattern region and an outer ring pattern region of a dial pattern;

FIG. 6 shows an embodiment of a translucent region located at an outer ring pattern region of a dial pattern;

FIG. 7 is a block diagram showing a control structure of a touch control module of the disclosure;

FIG. 8 shows an embodiment of operation of a touch control module in the disclosure in response to a user's touch behavior; and

FIG. 9 shows another embodiment of operation of a touch control module in the disclosure in response to a user's touch behavior.

### DETAILED DESCRIPTION OF THE EMBODIMENTS

The following describes specific embodiments of the disclosure in more details with reference to the schematic diagrams. Based on the following description and a patent scope of the disclosure, advantages and features of the disclosure will be clearer. It should be noted that, the accompanying drawings are in simplified forms and are not drawn to an accurate scale, and are only used for assisting in describing the embodiments of the disclosure conveniently and clearly.

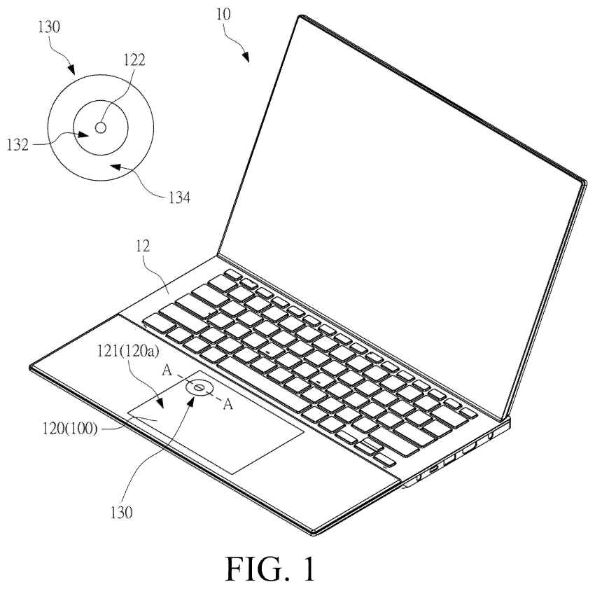

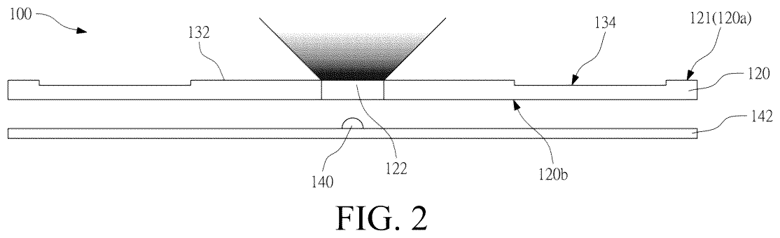

FIG. 1 is a schematic outside view of a touch control module 100 according to a first embodiment of the disclosure. A left side of the figure is a top view of a dial pattern 130 on a touch pad 120. FIG. 2 is a schematic cross-sectional view corresponding to a section line A-A in FIG. 1.

The touch control module 100 is provided on an electronic device 10, and serves as an input interface of the electronic device 10. In an embodiment, the electronic device 10 is a notebook computer.

As shown in the figure, the touch control module 100 includes the touch pad 120 and at least one light-emitting element 140 (only one light-emitting element 140 is shown in the figure to serve as an example). The touch pad 120 is located in the middle of a front part (a side close to a user) of an operation surface 12 of the electronic device 10. A rear part of the operation surface 12 is provided with a keyboard. In other embodiments, the touch pad 120 also covers an entire front part of the operation surface 12. Alternatively, the touch pad 120 is arranged at the rear part of the operation surface 12.

A front side 120a of the touch pad 120 includes a touch surface 121, the touch surface 121 includes a translucent region 122, and the touch surface 121 includes a dial pattern 130 at a position corresponding to the translucent region 122. In an embodiment, the dial pattern 130 is close to an edge of the touch surface 121.

The dial pattern 130 includes an inner circle pattern region 132 and an outer ring pattern region 134. In this embodiment, the touch surface 121 includes a ring-shaped concave structure, so as to form a step between the inner circle pattern region 132 and the outer ring pattern region 134, thereby presenting the dial pattern 130. In other embodiments, the inner circle pattern region 132 and the outer ring pattern region 134 have different surface structures. In an embodiment, the inner circle pattern region 132 has a smooth surface and the outer ring pattern region 134 has a rough surface. Alternatively, the inner circle pattern region 132 and the outer ring pattern region 134 have different colors to present the dial pattern 130.

The light-emitting element 140 is arranged at a back side 120b of the touch pad 120, and corresponds to the translucent region 122. In this embodiment, the light-emitting element 140 is arranged on a circuit board 142, and aims at the translucent region 122. In other words, the light-emitting element 140 projects light to the translucent region 122 in a direct-light manner.

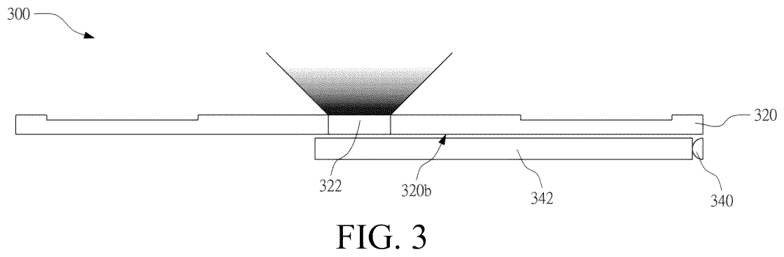

FIG. 3 is a schematic cross-sectional view of a touch control module 300 according to a second embodiment of the disclosure.

Different from the touch control module 100 in the first embodiment, a light-emitting element 340 of the touch control module 300 in this embodiment is arranged at the back side 320b of the touch pad 320 in a side-light-incoming manner. Light generated by the light-emitting element 340 is transmitted laterally through a light guide plate 342 and then projected outward through the translucent region 322.

Back to FIG. 1, in the embodiment of FIG. 1, the translucent region 122 is located at the inner circle pattern region 132, and corresponds to a center of the inner circle pattern region 132. In other embodiments, the translucent region 122 is located at other positions of the inner circle pattern region 132; alternatively, the translucent region 122 is located at the outer ring pattern region 134 or a junction of the inner circle pattern region 132 and the outer ring pattern region 134.

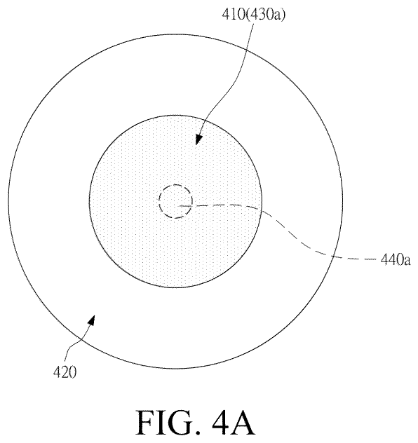

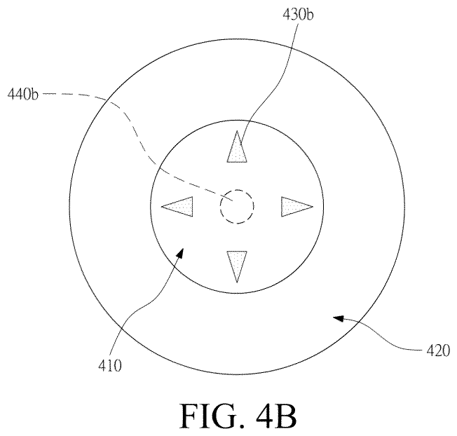

FIG. 4A and FIG. 4B show two embodiments of translucent regions 430a and 430b within an inner circle pattern region 410 of a dial pattern. In the embodiments of FIG. 4A and FIG. 4B, the translucent regions 430a and 430b are located at the inner circle pattern region 410, and the outer ring pattern region 420 does not include the translucent regions 430a and 430b.

In the embodiment shown in FIG. 4A, a size of the translucent region 430a is substantially equal to a size of the inner circle pattern region 410. The translucent region 430a corresponds to a single light-emitting element 440a, as shown in the figure. In some other embodiments, the translucent region 430a corresponds to a plurality of light-emitting elements. Alternatively, the light-emitting element 440a is projected onto the translucent region 430a through a diffusion sheet, to provide uniform light.

In the embodiment shown in FIG. 4B, a plurality of independent translucent regions 430b (there are four arrow-shaped translucent regions 430b in this embodiment) is formed in the inner circle pattern region 410 and is symmetrically distributed in the inner circle pattern region 410.

In an embodiment, the translucent regions 430b correspond to a same light-emitting element 440b, as shown in the figure. In other embodiments, the translucent regions 430b correspond to light-emitting elements respectively. The light-emitting elements emit light in turn to present various light-emitting effects.

In the foregoing embodiment, the translucent regions 430a and 430b are located inside the inner circle pattern region 410.

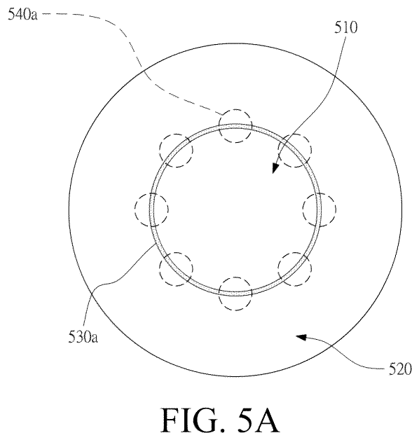

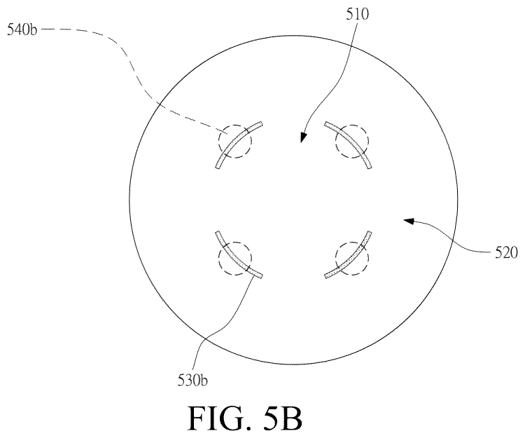

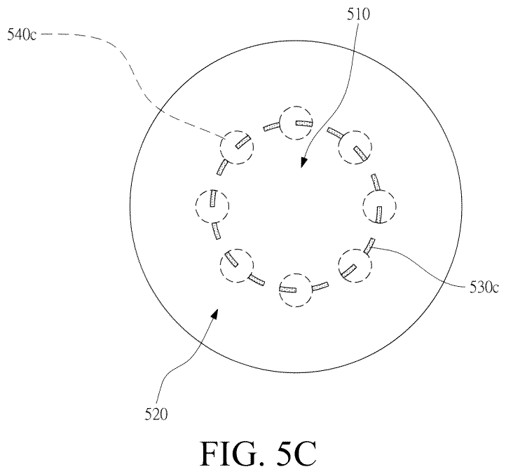

FIG. 5A to FIG. 5C show three embodiments of translucent regions 530a, 530b, and 530c located at a junction of an inner circle pattern region 510 and an outer ring pattern region 520 of a dial pattern.

In the embodiment shown in FIG. 5A, the translucent region 530a is in a complete ring shape. In cooperation with the translucent region 530a, a plurality of light-emitting elements 540a is arranged at the back side of the touch pad (not shown in the figure, for a specific location, refer to FIG. 2) and is arranged along the junction of the inner circle pattern region 510 and the outer ring pattern region 520, so as to facilitate uniform light emission of the translucent region 530a.

Different from the embodiment of FIG. 5A, in the embodiments of FIG. 5B and FIG. 5C, a plurality of translucent regions 530b and 530c is formed at the junction of the inner circle pattern region 510 and the outer ring pattern region 520. The translucent regions 530b and 530c are arc-shaped and symmetrically distributed around the inner circle pattern region 510, and are arranged along the junction of the inner circle pattern region 510 and the outer ring pattern region 520. In other words, in the embodiments of FIG. 5B and FIG. 5C, the translucent region 530a in the embodiment of FIG. 5A is evenly divided into a plurality of sections for light emission.

In cooperation with the translucent regions 530b and 530c, a plurality of light-emitting elements 540b and 540c is arranged at the back side of the touch pad and is arranged along the junction of the inner circle pattern region 510 and the outer ring pattern region 520. The light-emitting elements 540b and 540c facilitate uniform light emission of the translucent regions 530b and 530c. Besides, by properly controlling a light-emitting sequence of the light-emitting elements 540b and 540c, a dynamic light-emitting effect is presented in the translucent regions 530b and 530c.

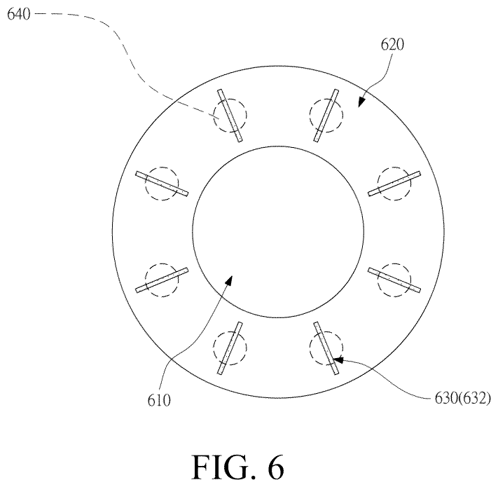

FIG. 6 shows an embodiment of a translucent region 630 located at an outer ring pattern region 620 of a dial pattern.

Different from the touch control module 100 provided in the first embodiment in which the location of the translucent region 122 is located at the inner circle pattern region 132, a location of the translucent region 630 in this embodiment corresponds to the outer ring pattern region 620. The translucent region 630 is not arranged in the inner circle pattern region 610.

As shown in the figure, the dial pattern of this embodiment is formed with a plurality of linear-shaped translucent regions 630 symmetrically distributed in the outer ring pattern region 620, and presents a radial outside view in the outer ring pattern region 620. In cooperation with the translucent region 630, a plurality of light-emitting elements 640 is arranged in a ring shape at a position corresponding to the outer ring pattern region 620 on the back side of the touch pad, so as to facilitate uniform light emission of the translucent region 630. Besides, by properly controlling a light-emitting sequence of the light-emitting elements 640, a dynamic light-emitting effect is presented in the translucent region 630.

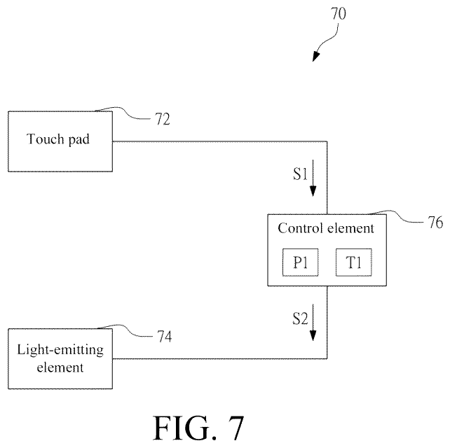

FIG. 7 is a block diagram showing a control structure of a touch control module 70 of the disclosure.

As shown in the figure, the touch control module 70 includes a touch pad 72, at least one light-emitting element 74 (only one light-emitting element 74 is shown in the figure to serve as an example), and a control element 76. The control element 76 is electrically coupled to the touch pad 72 and the at least one light-emitting element 74. The control element 76 is configured to receive a touch signal S1 through the touch pad 72, and confirm whether a touch position or a touch track corresponding to the touch signal S1 satisfies a preset touch position P1 or a preset touch track T1. When the touch position or the touch track corresponding to the touch signal S1 satisfies the preset touch position P1 or the preset touch track T1, a control signal S2 is generated according to the touch signal S1 to control the at least one light-emitting element 74 to emit light.

In an embodiment, the preset touch position P1 is within the dial pattern, for example, in the inner circle pattern region or the outer ring pattern region. In an embodiment, the preset touch track T1 is an arc track falling within the outer ring pattern region.

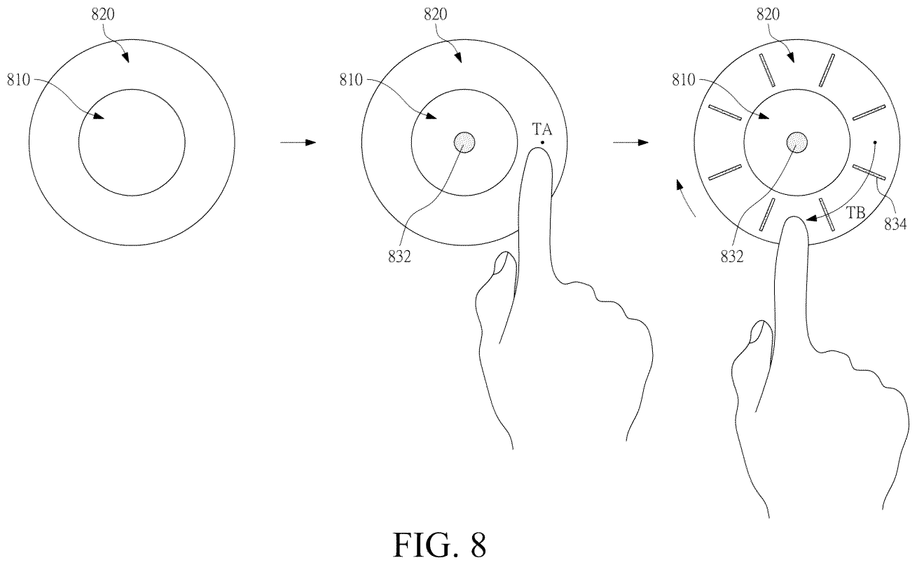

FIG. 8 shows an embodiment of operation of a touch control module in the disclosure in response to a user's touch behavior. The touch control module in the figure is a touch control module including both the translucent region 122 and the light-emitting element 140 in the embodiment of FIG. 1 and the translucent region 630 and the light-emitting element 640 in the embodiment of FIG. 6.

When the touch control module detects a touch behavior TA corresponding to the outer ring pattern region 820, a light-emitting element arranged at a center of the inner circle pattern region 810 is immediately lit, to make a translucent region 832 in the inner circle pattern region 810 emit light.

Subsequently, when the touch control module detects a touch track TB of moving along the outer ring pattern region 820, a light-emitting element located at the outer ring pattern region 820 is immediately lit, to make a translucent region 834 in the outer ring pattern region 820 emit light.

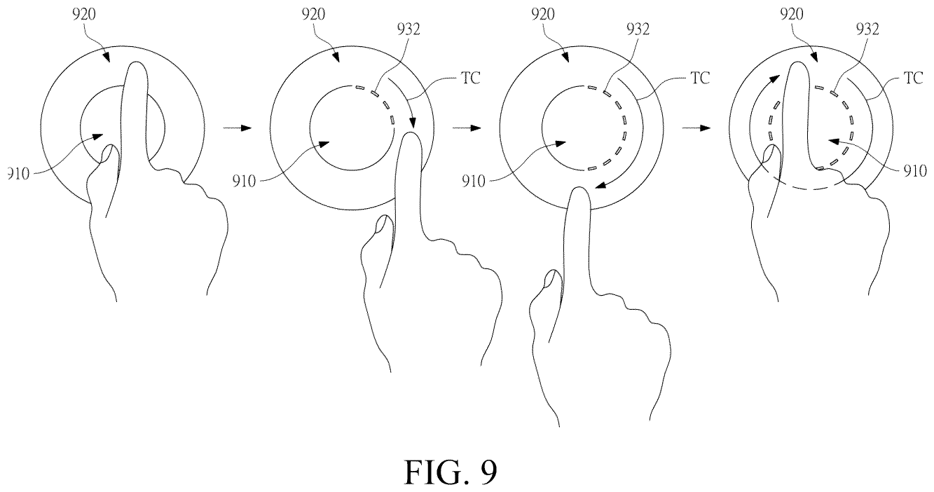

FIG. 9 shows another embodiment of operation of a touch control module in the disclosure in response to a user's touch behavior. The touch control module in the figure is a touch control module including the translucent region 530c and the light-emitting element 540c in the embodiment of FIG. 5C.

When the touch control module detects a touch track TC of moving along the outer ring pattern region 920, the touch control module lights up light-emitting elements in sequence according to the touch track TC, to make a corresponding translucent region 930 emit light. When the touch track TC goes around a full circle, all light-emitting elements are lit, making all translucent regions 930 emit light.

In summary, the touch control module 100 provided in the disclosure forms the dial pattern on the touch pad 120, and includes the translucent region that generates a light-emitting pattern to prompt a user. This helps the user to use the touch pad to operate a dial, so as to expand functions of the touch pad. In the disclosure, the dial pattern is formed on the touch pad to provide a dial function, which avoids a problem of insufficient internal space of an electronic device when a physical dial is provided on the electronic device.

The foregoing merely describes preferred embodiments of the disclosure, and are not intended to limit the disclosure. Any form of equivalent replacements or modifications made by a person skilled in the art to the technical means and technical content disclosed in the disclosure without departing from the scope of the technical means of the disclosure do not depart from the content of the technical means of the disclosure and still fall within the protection scope of the disclosure.

What is claimed is:

1. A touch control module, comprising:
a touch pad, comprising a front side and a back side opposite to each other, wherein the front side comprises a touch surface, the touch surface comprises a translucent region, the touch surface comprises a dial pattern at a position corresponding to the translucent region, and the dial pattern comprises an inner circle pattern region and an outer ring pattern region; and
at least one light-emitting element, arranged at the back side, and corresponding to the translucent region.

2. The touch control module according to claim 1, wherein surface structures of the inner circle pattern region and the outer ring pattern region are different.

3. The touch control module according to claim 1, wherein a step exists between the inner circle pattern region and the outer ring pattern region.

4. The touch control module according to claim 1, wherein the translucent region is at a position corresponds to the inner circle pattern region.

5. The touch control module according to claim 1, wherein the translucent region is at a position corresponds to the outer ring pattern region.

6. The touch control module according to claim 1, wherein the translucent region is at a position corresponds to a junction of the inner circle pattern region and the outer ring pattern region.

7. The touch control module according to claim 1, wherein the touch control module comprises a control element, the control element is electrically coupled to the touch pad and the at least one light-emitting element, the control element is configured to receive a touch signal through the touch pad, and when a touch position or a touch track corresponding to the touch signal satisfies a preset touch position or a preset touch track, the control element controls the at least one light-emitting element to emit light according to the touch signal.

8. The touch control module according to claim 7, wherein the preset touch position falls within the dial pattern.

9. The touch control module according to claim 8, wherein the preset touch position falls within the outer ring pattern region.

10. The touch control module according to claim 7, wherein a quantity of light-emitting elements is plural, and the plurality of light-emitting elements is lit up in sequence according to the touch track of the touch signal.

11. The touch control module according to claim 10, wherein the plurality of light-emitting elements is arranged along a junction between the inner circle pattern region and the outer ring pattern region.

12. The touch control module according to claim 1, wherein the translucent region is located at a center of the inner circle pattern region.

13. The touch control module according to claim 1, wherein the dial pattern is located at an edge of the touch pad.

14. The touch control module according to claim 1, wherein the touch surface comprises a ring-shaped concave structure to form the dial pattern.
